(19) United States
(12) Patent Application Publication
(10) Pub. No.: US 2024/0160970 A1
(43) Pub. Date: May 16, 2024

(54) OPTIMIZATION SYSTEM, OPTIMIZATION METHOD, AND RECORDING MEDIUM

(71) Applicant: NEC Corporation, Tokyo (JP)

(72) Inventor: Kei TAKEMURA, Tokyo (JP)

(73) Assignee: NEC Corporation, Tokyo (JP)

(21) Appl. No.: 18/383,247

(22) Filed: Oct. 24, 2023

(30) Foreign Application Priority Data
Nov. 7, 2022 (JP) 2022-177862

(51) Int. Cl. G06N 7/08

(52) U.S. Cl. CPC G06N 7/08

(57) ABSTRACT

The optimization system includes an acquisition unit, an amplification unit, a weight calculation unit, and an output unit. The acquisition unit acquires a loss caused as a result of decision-making by a plurality of experts in repetition of decision-making in which the plurality of experts are weighted and combined. The amplification unit amplifies each of the plurality of experts into a plurality of experts having different timings for initializing the information on the weight. The weight calculation unit calculates the weight of decision-making of each of the plurality of experts based on the weight of decision-making calculated using the loss for each of the experts amplified. The output unit outputs a weight of the decision-making of each of the plurality of experts.

This application is based upon and claims the benefit of priority from Japanese Patent Application No. 2022-177862, filed on Nov. 7, 2022, the disclosure of which is incorporated herein in its entirety by reference.

### TECHNICAL FIELD

The present disclosure relates to an optimization system and the like.

### BACKGROUND ART

In a decision-making system, decision-making related to behavior may be performed by weighting and combining decision-making by each of a plurality of experts. In the decision-making system, sequential optimization may be performed for each decision-making based on a loss in the decision-making calculated from the decision-making by the expert and observation data of behavior based on the decision-making. The sequential optimization is also referred to as online optimization. By repeating the sequential optimization, for example, the accuracy of decision-making can be improved. Meanwhile, when the plurality of experts make a decision by a combination of the decision-making, an expert excellent in the decision-making may change due to a change in environment. An expert who is excellent in the decision-making has a larger weight than other experts. Therefore, when the environment changes, the accuracy of the decision-making by a combination of the plurality of experts may decrease. Therefore, it is desirable to be able to suppress the influence on the decision-making due to the change in environment in the decision-making by a combination of the plurality of experts.

Non-Patent Literature 1 (Chen-Yu Wei, et al., “Tracking the Best Expert in Non-stationary Stochastic Environments”, Advances in Neural Information Processing Systems 29 (NIPS 2016)) uses an optimization method for further amplifying a plurality of experts to the plurality of experts when optimizing weights of the plurality of experts in decision-making in order to suppress an influence of a change in environment on decision-making.

### SUMMARY

An object of the present disclosure is to provide an optimization system and the like that can efficiently optimize a weight of each of a plurality of experts in decision-making by the plurality of experts.

According to an aspect of the present disclosure, there is provided an optimization system including: an acquisition unit that acquires a loss caused as a result of decision-making by a plurality of experts in repetition of decision-making in which the plurality of experts are weighted and combined; an amplification unit that amplifies each of the plurality of experts into a plurality of experts having different timings for initializing information on weights; a weight calculation unit that calculates a weight of the decision-making of each of the plurality of experts based on a weight of the decision-making calculated using the loss for each of the experts amplified; and an output unit that outputs the weight of the decision-making of each of the plurality of experts.

According to another aspect of the present disclosure, there is provided an optimization method including: acquiring a loss caused as a result of decision-making by a plurality of experts in repetition of decision-making in which the plurality of experts are weighted and combined; amplifying each of the plurality of experts into a plurality of experts having different timings of initializing the information on weights; calculating a weight of the decision-making of each of the plurality of experts based on a weight of decision-making calculated using the loss for each of the experts amplified; and outputting the weight of the decision-making of each of the plurality of experts.

According to still another aspect of the present disclosure, there is provided a for non-transitory recording medium recording an optimization program that causes a computer to execute: acquiring a loss caused as a result of decision-making by a plurality of experts in repetition of decision-making in which the plurality of experts are weighted and combined; amplifying each of the plurality of experts into a plurality of experts having different timings of initializing the information on weights; calculating a weight of the decision-making of each of the plurality of experts based on a weight of decision-making calculated using the loss for each of the experts amplified; and outputting the weight of the decision-making of each of the plurality of experts.

### BRIEF DESCRIPTION OF THE DRAWINGS

Exemplary features and advantages of the present disclosure will become apparent from the following detailed description when taken with the accompanying drawings in which:

FIG. 1 is a diagram illustrating an outline of a configuration of one embodiment of the present disclosure;

FIG. 2 is a diagram schematically illustrating an example of a timing at which information on a weight is initialized in one embodiment of the present disclosure;

FIG. 3 is a diagram illustrating an example of a configuration of an optimization system according to one embodiment of the present disclosure;

FIG. 4 is a diagram illustrating an example of a graph illustrating a change in loss in one embodiment of the present disclosure;

FIG. 5 is a diagram illustrating an example of a graph illustrating a time required for calculating a weight in one embodiment of the present disclosure;

FIG. 6 is a diagram illustrating an example of an operation flow of the optimization system in one embodiment of the present disclosure;

FIG. 7 is a diagram illustrating an example of a hardware configuration of the optimization system according to one embodiment of the present disclosure;

FIG. 8 is a diagram illustrating an example of processing of a sequential decision-making system according to one embodiment of the present disclosure;

FIG. 9 is a diagram illustrating an example of hospital data in one embodiment of the present disclosure; and

FIG. 10 is a diagram illustrating an example of medical worker data in one embodiment of the present disclosure.

### EXAMPLE EMBODIMENT

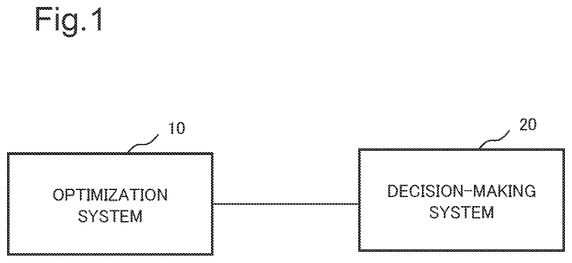

Embodiments of the present disclosure will be described in detail with reference to the drawings. FIG. 1 is a diagram illustrating an example of a configuration of a sequential decision-making system according to the present embodiment.

The sequential decision-making system includes an optimization system 10 and a decision-making system 20. The optimization system 10 is connected to the decision-making system 20 via, for example, a network. The optimization system 10 and the decision-making system 20 may be an integrated system. A plurality of decision-making systems 20 may be provided. The configuration of the sequential decision-making system can be designed as appropriate.

The sequential decision-making system is a system that repeats a series of flows of decision-making by a plurality of experts, observation data of results of behavior performed based on the decision-making, calculation of a loss based on the observation data, and optimization of parameters used for decision-making based on the loss. The decision-making is performed by combining decision-making of a plurality of experts by using weights of the experts optimized.

Each of the plurality of experts is a subject (or system) that performs decision-making. Each of the plurality of experts is, for example, a learning model generated by machine learning. The decision-making of each of the plurality of experts is an action in which an expert selects behavior. For example, the decision-making of each of the plurality of experts is an inference result of the learning model. The decision-making by the plurality of experts is performed, for example, by combining inference results of the learning models. The decision-making by the plurality of experts is performed by, for example, combining the learning models by weighting the learning models. The weight is, for example, a coefficient of each learning model when the learning models are combined. Each of the plurality of experts may be a prediction expression generated by regression analysis. Each of the plurality of experts is not limited to the above. For example, each of the plurality of experts may be a model for decision-making according to a predetermined rule. Each of the plurality of experts may be an expert who performs inference.

The observation data of the result of the behavior performed based on the decision-making is data obtained by observing an event that has occurred by the behavior according to the decision-making. In a case where the expert is the learning model, the observation data is data obtained by observing an event that has occurred by the behavior according to the inference result of the learning model. For example, the difference is a difference between the decision-making and the observation data. In a case where the expert is the learning model, the loss is, for example, a difference between an inference result by the learning model and an actual event.

The sequential decision-making system optimizes weights of experts in decision-making by, for example, feeding back results of decision-making by the plurality of experts once and calculating weights of the experts so as to minimize a loss. As described above, a method of sequentially and repeatedly performing optimization by decision-making and feedback of a result for each decision-making is also referred to as online optimization.

The online optimization is applied to, for example, a prediction target having a large change according to the environment. The online optimization is used, for example, for demand prediction, determination of order quantity, determination of price by dynamic pricing, or selection of stock portfolio. The application destination of the online optimization is not limited to the above.

In the sequential decision-making system, the optimization system 10 calculates the weight of decision-making of each of the plurality of experts in decision-making performed using decision-making by the plurality of experts. The weight of the decision-making is a real value corresponding to each of the plurality of experts. For example, the sum of the weights of the plurality of experts is 1. When the sum of the weights is 1, the weight of decision-making of each of the plurality of experts indicates a specific weight in the entire decision-making. The optimization system 10 optimizes the weight so as to minimize the loss in the decision-making based on the loss up to the decision-making for which the weight is calculated. An example of a method of calculating the weight of the decision-making will be described later. Then, the optimization system 10 outputs, to the decision-making system 20, for example, the weight for the decision-making by each of the plurality of optimized experts.

When the weights of the decision-making by the plurality of optimized experts are acquired, the decision-making system 20 performs the decision-making by combining the decision-making by the plurality of experts using the weights of the optimized experts, for example. The decision-making system 20 acquires the observation data of results of the behavior performed based on the decision-making. Then, the decision-making system 20 calculates the loss in the decision-making based on the decision-making and the observation data of the behavior based on the decision-making. The decision-making system 20 outputs the calculated loss to the optimization system 10, for example. That is, the decision-making system 20 outputs the loss to the optimization system 10 as feedback to the optimization result of the weight of the decision-making. Based on the loss acquired from the decision-making system 20, the optimization system 10 optimizes the weight in the decision-making of each of the plurality of experts so as to minimize the loss.

When calculating the weight of each expert, the optimization system 10 further amplifies each expert into the plurality of experts. When calculating the weight of each expert, the optimization system 10 further amplifies each expert into the plurality of experts to virtually increase the number of experts. Then, the optimization system 10 calculates the weight of each of the experts before being amplified by calculating the weight of each of the experts amplified. To further amplify each of the experts to the plurality of experts means, for example, to consider that each of the experts is further constituted by the plurality of experts. That is, when each of the plurality of experts is a parent expert, the optimization system 10 considers that each of the parent experts is constituted by an assembly of a plurality of child experts. The parent expert and the child expert amplified from the parent expert have the same decision-making content. As described above, in the optimization system 10, each of the plurality of experts performs processing of calculating the weight assuming that each of the plurality of experts is an assembly of the plurality of experts.

The optimization system 10 initializes information on the weight at different timings for the plurality of amplified experts. The different timing means, for example, that the repetition of the decision-making for initializing the weight is different between the repetition of the decision-making and the optimization. Initializing the information on the weight means, for example, using a value based on a mathematical expression not using the weight at the time of past decision-making as a variable as the information on the weight.

The optimization system 10 amplifies each of the plurality of experts to an expert of the number of values calculated by a logarithmic function having the number of times of repetitions of the optimization as a variable. The logarithmic function for calculating the number of amplified experts is, for example, Log₂(T), where T is the number of times of repetitions of optimization. At this time, assuming that the number of experts before amplification is K, the total number of experts amplified is, for example, K×Log₂ (T).

In a case where the logarithmic function for calculating the number of amplified experts is Log₂(T), the optimization system initializes the information on the weight when calculating the weight for the s-th expert among the amplified experts based on the loss in the decision-making in 2^{s-1}. The value of the base of the logarithmic function may be other than 2. In a case where the value of the base of the logarithmic function is B (B is a positive integer), the optimization system 10 initializes the information on the weight, for example, when calculating the weight for the s-th expert among the amplified experts based on the loss in the decision-making of B^{s-1}.

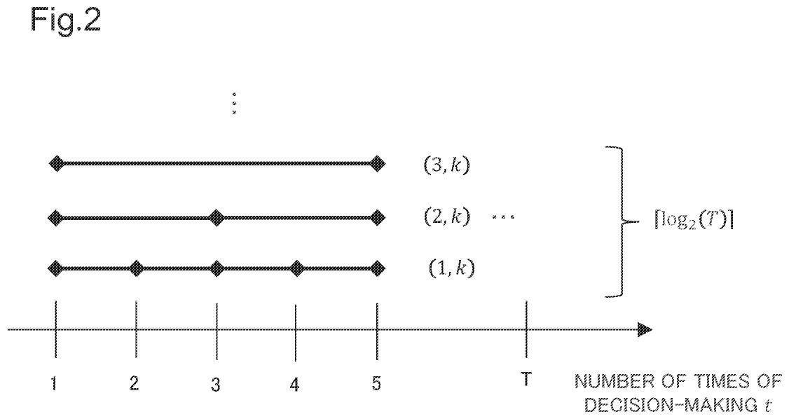

FIG. 2 is a diagram schematically illustrating an example of a timing for initializing information on the weight. In the example of FIG. 2, horizontal lines with diamonds indicate the decision-making by the amplified expert. In the example of FIG. 2, the lowermost horizontal line of (1, k) among the horizontal lines with diamonds indicates the decision-making by the first expert among the experts obtained by amplifying the kth expert. In the first expert, for example, s=1. In the example of FIG. 2, the horizontal line of (2, k) in the middle of the horizontal lines with diamonds indicates the decision-making by the second expert among the experts obtained by amplifying the kth expert. In the second expert, for example, s=2. In the example of FIG. 2, the uppermost horizontal line of (3, k) among the horizontal lines with diamonds indicates the decision-making by the third expert among the experts obtained by amplifying the kth expert. In the third expert, for example, s=3.

In the example of FIG. 2, the number of times of the decision-making indicated by the diamond is the timing for initializing information on the weight. In the example of FIG. 2, in the expert of s=1 indicated as (1, k), since 2^{s-1} is 1, the information on the weight is initialized every time the decision-making is repeated. The expert with s=1 is the first expert among the amplified experts. In the example of FIG. 2, since 2^{s-1} is 2 in the expert of s=2 indicated as (2, k), the information on the weight is initialized once every two times in a case where the decision-making is repeatedly performed. That is, in the example of FIG. 2, the expert with s=2 is initialized when the number of times of repetitions is 1, 3, and 5. The expert with s=2 is the second expert among the amplified experts. In the example of FIG. 2, in the expert of s=3 indicated as (3, k), since 2^{s-1} is 4, the information on the weight is initialized once every four times in a case where decision-making is repeatedly performed. That is, in the example of FIG. 2, the expert of s=3 is initialized when the number of times of repetitions is 1 and 5. The expert with s=3 is the third expert among the amplified experts. The expert of s=Log₂(T) is not initialized even once during the repetition of decision-making up to the Tth time. As described above, the optimization system 10 initializes the information on the weight for each of the plurality of experts at different timings for each amplified expert. By initializing the information on the weight at different timings, it is possible to suppress a decrease in accuracy of the decision-making due to a change in environment.

The online optimization may be used for hyperparameter search of a machine learning model. In this case, each of the plurality of experts is a machine learning model having different hyperparameters. The hyperparameter in the machine learning model refers to a parameter that cannot be determined in learning. For example, the hyperparameter refers to a degree of influence of a normalization term of a loss function.

The optimization system 10 may calculate the weight of each machine learning model using online optimization for a plurality of machine learning models having different hyperparameters. The optimization system 10 displays the weight (that is, the importance) of the hyperparameter to the user by outputting the weight of each machine learning model to the user, for example. That is, by using the optimization system 10, the user can determine an appropriate hyperparameter in the machine learning model.

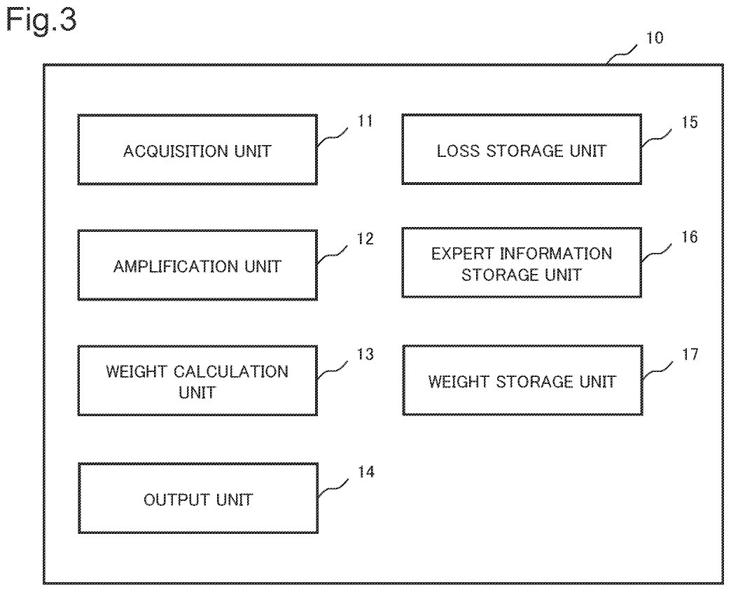

Here, an example of a specific configuration of the optimization system 10 will be described. FIG. 3 is a diagram illustrating an example of a configuration of the optimization system 10. The optimization system 10 includes an acquisition unit 11, an amplification unit 12, a weight calculation unit 13, and an output unit 14 as a basic configuration. The optimization system 10 includes, for example, a loss storage unit 15, an expert information storage unit 16, and a weight storage unit 17.

The acquisition unit 11 acquires the loss caused as the result of decision-making by the plurality of experts in repetition of decision-making in which the plurality of experts are weighted and combined. The acquisition unit 11 acquires, for example, the loss generated as the result of the decision-making by the plurality of experts from the decision-making system. The loss is calculated, for example, based on the decision-making by the plurality of experts and the observation data of the behavior performed based on the result of the decision-making. The observation data is, for example, data obtained by observing the result of the behavior performed based on the decision-making.

In a case where each of the plurality of experts is a prediction model that predicts a sales amount of a product, the decision-making is, for example, prediction of the sales amount of the product. At this time, the observation data is an actual sales amount in a case where a product is prepared based on the decision-making. The loss is a difference between the prediction of the sales amount of the product by the prediction model and the actual sales amount. The prediction model is, for example, the learning model generated by the machine learning. The prediction model may be a prediction expression of a sales amount generated by regression analysis. The prediction model is not limited to the above.

The acquisition unit 11 may acquire observation data of decision-making of each of the plurality of experts and the behavior based on the decision-making. In a case where the decision-making of each of the plurality of experts and the observation data are acquired, for example, the weight calculation unit 13 calculates the loss.

The amplification unit 12 amplifies each of the plurality of experts into the plurality of experts having different timings for initializing the information on the weight. For example, the amplification unit 12 amplifies each of the plurality of experts into experts of the number of values calculated by the logarithmic function. For example, assuming that the number of times of decision-making is T, the amplification unit 12 amplifies each of the plurality of experts as many as the number of Log₂(T) experts. The value of the base of the logarithmic function may be other than 2. The value calculated by the logarithmic function may be, for example, a value obtained by multiplying the value calculated by the logarithmic function by a coefficient.

The amplification unit 12 amplifies each of the plurality of experts so as to include at least one expert whose information on the weight is not initialized in the entire period of the number of times of decision-making. For example, in a case where each of a plurality of experts is amplified to an expert of the number of Log₂(T), the amplified expert includes an expert in which information on the weight is not initialized in the entire period of the number of times of decision-making. The expert whose information on the weight is not initialized in the entire period of the number of times of decision-making corresponds to each of the plurality of experts in a case where amplification is not performed.

The amplification unit 12 may amplify each of the plurality of experts so that two or more experts whose information on the weight is not initialized are included in the entire period of the number of times of decision-making. For example, the amplification unit 12 amplifies each of the plurality of experts into a number of experts obtained by adding a setting value to the number obtained by the logarithmic function with the number of times of decision-making as a variable, so that two or more

whose information on the weight is not initialized are included. The amplification unit 12 may amplify the plurality of experts into different numbers of experts. The amplification unit 12 stores the amplified information on the expert in the expert information storage unit 16, for example.

The weight calculation unit 13 calculates the weight of decision-making of each of the plurality of experts based on the weight of decision-making calculated using the loss for each of the experts amplified.

The weight calculation unit 13 calculates an amplified weight of decision-making for each expert by using the loss acquired by the acquisition unit 11. Then, the weight calculation unit 13 calculates the weight of decision-making of each of the plurality of experts based on the amplified weight of decision-making calculated for each expert. For example, the weight calculation unit 13 calculates the weight of the decision-making of the expert before amplification by adding the amplified weights of the decision-making of the experts. For example, the weight calculation unit 13 calculates the amplified weight of decision-making for each expert so as to minimize the loss by using the loss in decision-making before the decision-making for which the weight of decision-making is to be calculated. Then, for example, the weight calculation unit 13 calculates an optimized weight of decision-making of each of the plurality of experts by adding the amplified weight of decision-making of each of the experts.

The weight calculation unit 13 calculates information on the t-th weight by using the information on the t-lth weight in a case where the decision-making is repeatedly performed. The information on the weight is, for example, a parameter used for calculating the weight of the amplified expert. The information on the weight of the s-th expert among the amplified experts is initialized at a timing when the number of times of repetition of decision-making is every 2^{s-1} times. That is, at the timing when the number of times of repetitions of decision-making is every 2^{s-1} times, the information on the t-lth weight is not used in the calculation of the information on the t-th weight. As described above, the weight calculation unit 13 initializes the information on the weight at the timing when the number of times of repetitions of decision-making is 2^{s-1} times for each of the amplified experts, and calculates the weight of decision-making.

The processing of calculating the weight of the decision-making of each of the plurality of experts will be described with reference to a specific example.

A weight p_{t,k} of the expert k in the t-th decision-making in a case where each of the plurality of experts is amplified to the experts of the number of Log₂(T) is calculated using, for example, a mathematical expression illustrated in the following Expression 1.

p_{t,k}=Σₛ₌₁^{Log2(T)}p_{t,(s,k)} [Expression 1]

In Expression 1, p_{t,(s,k)} is the weight of the s-th expert among the experts amplified from the expert k in the t-th decision-making. In Expression 1, the weight of the expert k in the t-th decision-making is the sum of the weights of the experts amplified from the expert k.

The weights p_{t,(s,k)} of the expert (s,k) amplified from the expert k in the t-th decision-making are calculated using, for example, a mathematical expression illustrated in the following Expression 2.

$${p}_{t , ( s , k )} = \frac{{η}_{t - 1 , ( s , k )} {\tilde{w}}_{t - 1 , ( s , k )}}{{\sum }_{i = 1}^{K} {\sum }_{s = 1}^{t} {η}_{t - 1 , ( s , i )} {\tilde{w}}_{t - 1 , ( s , i )}} \qquad [ Expression 2 ]$$

The information on the weight is, for example, each parameter used to calculate p_{t,(s,k)} in the mathematical expression illustrated in Expression 2. In the information on the weight, η_{t,(s,k)} is, for example, a parameter regarding loss determination. Among the information on the weight, w_{t,(s,k)} is, for example, a parameter reflecting a loss in a case where decision-making is repeated. The information on the weight used for the calculation of p_{t,(s,k)} is calculated using mathematical expressions illustrated in the following Expressions 3 and 4.

$${\tilde{w}}_{t - 1 , ( s , k )} = exp ( {w}_{t - 1 , ( s , k )} + {η}_{t - 1 , ( s , k )} {m}_{t , ( s , k )} \qquad [ Expression 3 ]$$

$${w}_{t , ( s , k )} = \frac{{η}_{t , ( s , k )}}{{η}_{t - 1 , ( s , k )}} ( {w}_{t - 1 , ( s , k )} + {η}_{t - 1 , ( s , k )} {r}_{t , ( s , k )} - {{η}_{t - 1 , ( s , k )}^{2} ( {r}_{t , ( s , k )} - {m}_{t , ( s , k )} )}^{2} ) \qquad [ Expression 4 ]$$

An initial value w_{0(s,k)} of w_{t,(s,k)} in the mathematical expression illustrated in Expression 4 is calculated using a mathematical expression illustrated in the following Expression 5.

$${w}_{0 , ( s , k )} = \frac{1}{{KT}^{′}} \qquad [ Expression 5 ]$$

T′ in the mathematical expression illustrated in Expression 5 is calculated using a mathematical expression illustrated in the following Expression 6. K in the mathematical expression illustrated in Expression 5 is the number of the plurality of experts.

T′=2^{log}^{₂}^{(T)} [Expression 6]

In the mathematical expressions illustrated in Expression 3 and Expression 4, η_{t,(s,k)} is calculated using a mathematical expression illustrated in the following Expression 7.

$${η}_{t , ( s , k )} = min \{ \frac{1}{4} , \sqrt{\frac{log ( K ( 2 {T}^{′} - 1 ) )}{( 1 + {\sum }_{s = 1}^{t} {( {r}_{s , ( s , k )} - {m}_{s , ( s , k )} )}^{2} )}} \} \qquad [ Expression 7 ]$$

γ_{t,(s,k)} and m_{t,(s,k)} in the mathematical expression illustrated in Expression 7 are calculated using the mathematical expressions illustrated in the following Expression 8 and Expression 9.

r_{t,(s,k)}=Σᵢ₌₁^{K}p_{t,i} [symbol] _{t,i} [symbol] _{t,(s,k)} [Expression 8]

γ_{t,(s,k)} is, for example, a parameter related to the loss in the t-th decision-making.

m_{t,(s,k)}=Σᵢ₌₁^{K}p_{t,i} [symbol] _{t-t,i}− [symbol] _{t-1,(s-k)} [Expression 9]

m_{t,(s,k)} is, for example, a parameter related to the loss in the t−1th decision-making.

In the mathematical expression illustrated in Expression 8, 1_{t(s,k)} is a loss incurred by the expert (s,k) in the t-th decision. However, 1_{t(s,k)} satisfies a condition of a mathematical expression illustrated in the following Expression 10.

[symbol]

ⱼ₂_{^{s}}_{-1,(s,k)}=Σᵢ₌₁^{K}p_{t-1,i} [symbol] _{t-1,i}(j=1,2, . . . ) [Expression 10]

The weight calculation unit 13 stores, for example, information on the weight of each of the experts amplified in the weight storage unit 17. For example, the weight calculation unit 13 reads the information on the weight of each of the experts amplified from the weight storage unit 17 at a timing other than the timing of initializing the information on the weight. The weight calculation unit 13 stores, for example, the weight of the decision-making by each of the plurality of experts in the weight storage unit 17.

In a case where the acquisition unit 11 has acquired the decision-making of each of the plurality of experts and the observation data, the weight calculation unit 13 calculates the loss of each of the plurality of experts based on, for example, the decision-making and the observation data.

The output unit 14 outputs the weight of the decision-making of each of the plurality of experts. The output unit 14 outputs, for example, the weight of the decision-making of each of the plurality of experts to the decision-making system.

The output unit 14 may output at least one piece of history data of the loss in the decision-making, the loss of each of the plurality of experts, and the weight of the decision-making of each of the plurality of experts. The output unit 14 outputs the history data to, for example, a display device or a terminal device (not illustrated).

The loss storage unit 15 stores, for example, the loss of each of the plurality of experts acquired by the acquisition unit 11. The loss storage unit 15 stores, for example, the amplified loss of each expert.

The expert information storage unit 16 stores, for example, information on the amplification of the expert. The information on the amplification of the expert is, for example, the logarithmic function used for the amplification of the expert. The expert information storage unit 16 stores, for example, a timing of initializing information on the amplified weights of the experts.

The weight storage unit 17 stores, for example, the amplified weight of the decision-making of each expert. The weight storage unit 17 stores, for example, the weight for the decision-making of each of the plurality of experts.

The decision-making system 20 performs the decision-making by combining the decision-making of the plurality of experts using, for example, the weight of each expert optimized by the optimization system 10. The decision-making system 20 acquires the observation data of the behavior performed based on the decision-making. Then, the decision-making system 20 calculates the loss in the decision-making based on the decision-making and the observation data of the behavior performed based on the decision-making. The decision-making system 20 outputs the calculated loss to the optimization system 10. The decision-making system 20 acquires the weight in the decision-making for each of the plurality of experts optimized using the output loss. Then, the decision-making system 20 performs the decision-making by the plurality of experts using the optimized weight in the decision-making of each of the plurality of experts.

The decision-making system 20 may output the historical data of at least one of the loss in the decision-making, the loss of each of the plurality of experts, and the weight of the decision-making of each of the plurality of experts. The decision-making system 20 outputs the history data to, for example, the display device or the terminal device (not illustrated).

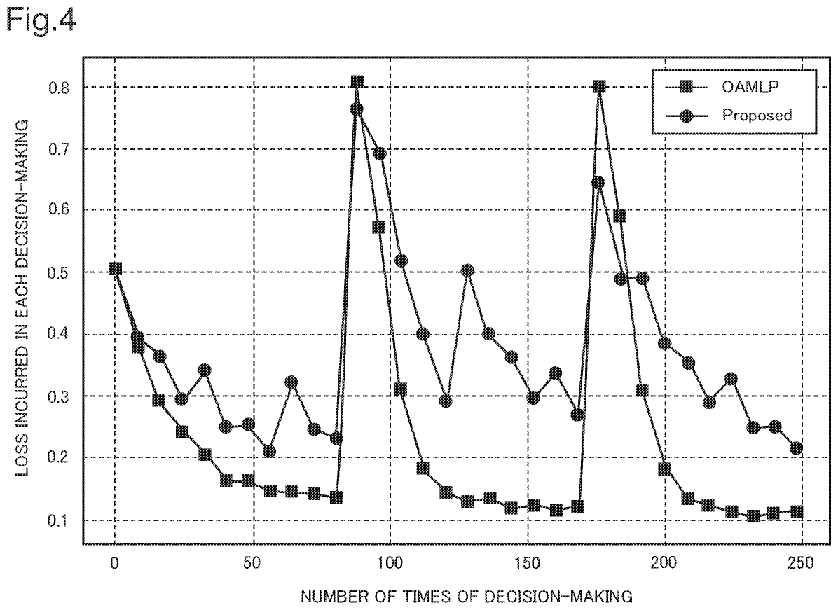

Here, an example of the loss change in repetition of the decision-making and the optimization of the weight based on the observation data of the behavior will be described. FIG. 4 is an example of a graph illustrating the change in loss in a case where the decision-making and the optimization of the weight based on the observation data of the behavior are repeated. The example of the graph of FIG. 4 illustrates, for example, an example of a change in loss based on decision-making by three experts. The “number of times of decision-making” on the horizontal axis in the example of the graph of FIG. 4 indicates the number of times of repetition of decision-making. In the example of the graph of FIG. 4, the decision-making and the optimization of the weight based on the observation data of the behavior are repeated 256 times. The “loss incurred in each decision-making” on a vertical axis in the example of the graph of FIG. 4 is a loss calculated using the observation data of behavior performed based on decision-making in each repetition count.

In the example of the graph of FIG. 4, “OAMLP” indicates a change in loss in a case where the optimization method described in Non-Patent Literature 1 is used. In the example of the graph of FIG. 4, “Proposed” indicates a change in loss in a case where the optimization of the weight in the present embodiment is performed. In the example of the graph of FIG. 4, the best expert changes twice in 256 repetitions. In the example of the graph of FIG. 4, for example, when the best expert changes due to a change in environment, the loss temporarily increases to about 0.8, but the loss decreases by repeating optimization. As illustrated in the example of the graph of FIG. 4, by amplifying each of the plurality of experts in both the optimization described in Non-Patent Literature 1 and the optimization of the present embodiment, the influence of the change in environment on the decision-making is suppressed.

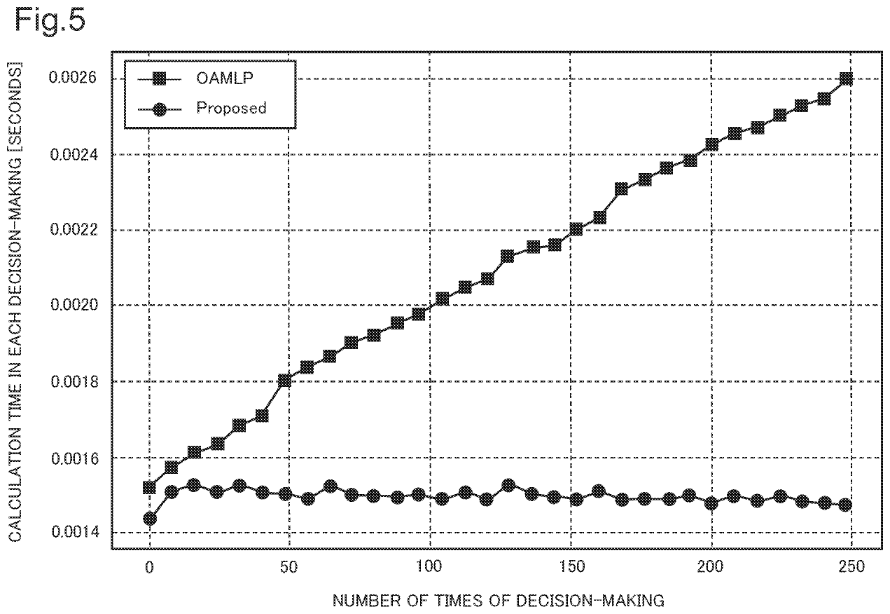

FIG. 5 is an example of a graph illustrating a time required for calculation in a case where the decision-making and the optimization of the weight based on the result are repeated. The example of the graph of FIG. 5 is based on, for example, the decision-making by three experts. The “number of times of decision-making” on a horizontal axis of the example of the graph of FIG. 5 indicates the number of times of repetition of the decision-making. In the example of the graph of FIG. 5, the decision-making and the optimization of the weight based on the result are repeated 256 times. A “calculation time in each decision-making” on a vertical axis of the example of the graph of FIG. 5 is time required for optimizing the weight of each decision-making in each number of repetitions. The unit of the vertical axis of the example of the graph of FIG. 5 is seconds.

In the example of the graph of FIG. 5, “OAMLP” indicates the time required to calculate the weight in a case where the optimization described in Non-Patent Literature 1 is used. In the example of the graph of FIG. 5, “Proposed” indicates the time required for the calculation of the weight in a case where optimization in the present embodiment is performed. In the example of the graph of FIG. 5, the best expert changes twice in 256 repetitions. In the example of the graph in FIG. 5, in the optimization described in Non-Patent Literature 1 indicated as “OAMLP”, the time required for calculating the weight increases as the number of times of repetitions increases. In the example of the graph of FIG. 5, in the optimization of Non-Patent Literature 1, the time required for calculating the weight per one time is proportional to K×T. Meanwhile, in the example of the graph of FIG. 5, in a case where the optimization in the present embodiment is performed, the time required for calculating the weight per one time is proportional to K×Log(t). Therefore, when the optimization in the present embodiment is performed, the time required for calculating the weight does not increase as in Non-Patent Literature 1. Therefore, as illustrated in the examples of the graphs in FIGS. 4 and 5, in a case where optimization in the present embodiment is performed, it is possible to suppress an increase in time required for calculating the weight while suppressing deterioration in accuracy of decision-making.

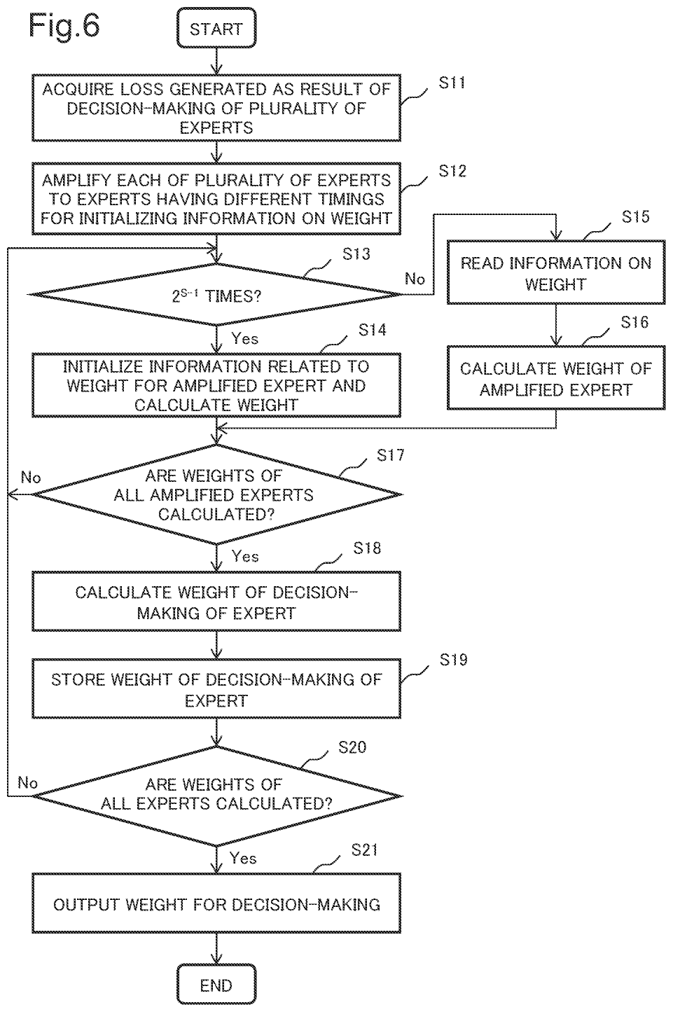

An operation of the optimization system 10 will be described. FIG. 6 is a diagram illustrating an example of an operation flow of the optimization system 10.

The acquisition unit 11 acquires the loss generated as the result of the decision-making of the plurality of experts (Step S11). The acquisition unit 11 acquires, from the decision-making system 20, for example, the loss generated as the result of the decision-making of the plurality of experts.

When the loss is acquired, the amplification unit 12 amplifies each of the plurality of experts to the experts having different timings for initializing the information on the weight (Step S12).

In a case where the number of times of repetitions of decision-making is 2^{s-1} times (Yes in Step S13), the weight calculation unit 13 initializes information related to the weight for the expert for which the weight for decision-making is not calculated among the amplified experts, and calculates the weight for the decision-making (Step S14).

In a case where the number of times of repetitions of the decision-making is not the timing of 2^{s-1} times (No in Step S13), the weight calculation unit 13 reads, for example, information on the weight calculated in the past from the weight storage unit 17 (Step S15). When the information on the weight is read, the weight calculation unit 13 calculates the weight of the decision-making for an expert for which the weight of decision-making has not been calculated among the amplified experts, using the read information on the weight (Step S16).

When the weight for the decision-making of the experts amplified in Step S14 or Step S16 has been calculated and the calculation of the weights for decision-making by all the experts amplified has been completed (Yes in Step S17), the weight calculation unit 13 calculates the weights for decision-making of the expert (Step S18). The weight calculation unit 13 calculates, for example, a sum of the amplified experts to calculate the weight of the decision-making of the expert before amplification.

After calculating the weight of the decision-making of the expert, the weight calculation unit 13 stores the weight of the decision-making of the expert and the weight of the decision-making of the amplification expert in the weight storage unit 17, for example (Step S19).

When the weight for decision-making has been stored in Step S19 and calculation of the weights for decision-making has been completed for all the experts (Yes in Step S20), the output unit 14 outputs the calculated weight for the decision-making of the plurality of experts (Step S21). The output unit 14 outputs, for example, the calculated weight of decision-making of each of the plurality of experts to the decision-making system 20.

In Step S17, when the calculation of the weights of the decision-making for all the amplified experts has not been completed (No in Step S17), the weight calculation unit 13 returns to Step S13 and repeats the processing related to the calculation of the weights of the decision-making for the amplified experts for which the calculation of the weights of the decision-making has not been completed.

In a case where the calculation of the weights of the decision-making has not been completed for all the experts in Step S20 (No in Step S20), the weight calculation unit 13 returns to Step S13 and repeats the processing related to the calculation of the weights of the decision-making for the experts for which the calculation of the weights of the decision-making has not been completed.

The optimization system 10 amplifies each of the plurality of experts into a plurality of experts having different timings for initializing the information on the weight. That is, the experts amplified from the same expert have different timings at which the information on the weight is initialized. For example, the optimization system 10 amplifies each of the plurality of experts to the number of amplification experts calculated by the logarithmic function having the number of times of repetitions of the optimization as a variable. Then, the optimization system 10 calculates the weight in the decision-making of each of the plurality of experts by calculating the amplified weight in the decision-making of each expert based on the loss caused by the decision-making. In this manner, by amplifying the information on the weights to experts having different timings of initialization and calculating the weights of the plurality of experts, it is possible to suppress the influence of the change in the environment on the decision-making. Therefore, even in a case where an expert who makes excellent decision is changed due to a change in environment, it is possible to suppress an influence on decision-making accuracy.

By amplifying experts having different timings at which the information on the weight is initialized, the number of experts after amplification can be suppressed. By suppressing the number of experts after amplification, it is possible to suppress the time required for calculating the weight of the decision-making of each of the plurality of experts. Since the number of experts after amplification is suppressed, it is possible to suppress the amount of storage area required to store information on the weight. Therefore, by using the optimization system 10, it is possible to suppress computer resources required for optimizing the weight of the decision-making. Therefore, by using the optimization system 10, it is possible to efficiently optimize the weight of each of a plurality of experts in decision-making by the plurality of experts.

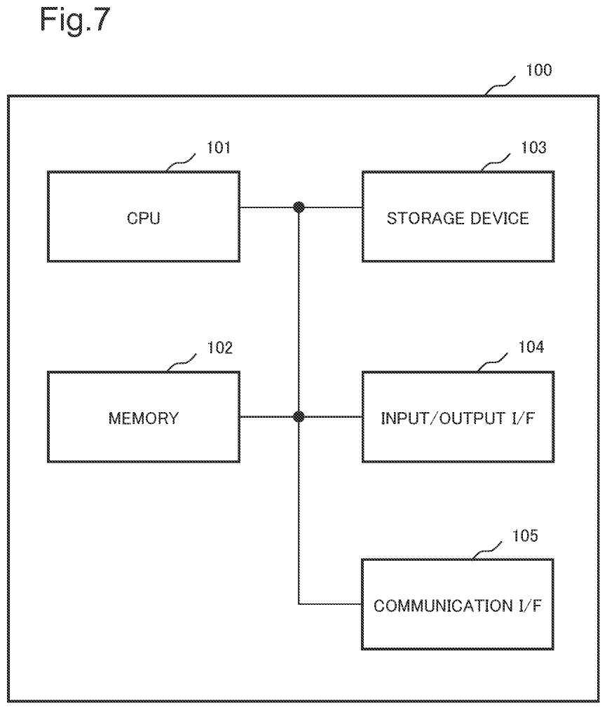

Each processing in the optimization system 10 can be achieved by executing a computer program on a computer. FIG. 7 illustrates an example of a configuration of a computer 100 that executes a computer program for performing each processing in the optimization system 10. The computer 100 includes, for example, a central processing unit (CPU) 101, a memory 102, a storage device 103, an input/output interface (I/F) 104, and a communication I/F 105.

The CPU 101 reads and executes a computer program for performing each processing from the storage device 103. The CPU 101 may be configured by a combination of a plurality of CPUs. The CPU 101 may be configured by a combination of a CPU and another type of processor. For example, the CPU 101 may include a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof. The memory 102 includes a dynamic random access memory (DRAM) or the like, and temporarily stores a computer program executed by the CPU 101 and data being processed. The storage device 103 stores a computer program executed by the CPU 101. The storage device 103 includes, for example, a nonvolatile semiconductor storage device. As the storage device 103, another storage device such as a hard disk drive may be used. The input/output I/F 104 is an interface that receives an input from an operator and outputs display data and the like. The communication I/F 105 is an interface that transmits and receives data to and from the decision-making system 20 or another information processing apparatus. Each processing in the decision-making system 20 can also be achieved by executing a computer program in a computer having a configuration similar to that of the computer 100.

The computer program used for executing each processing can also be distributed by being stored in a computer-readable recording medium that non-transiently records data. As the recording medium, for example, a magnetic tape for data recording or a magnetic disk such as a hard disk can be used. As the recording medium, an optical disk such as a compact disc read only memory (CD-ROM) can also be used. A non-volatile semiconductor storage device may be used as a recording medium.

### Application Example in Medical and Healthcare Field

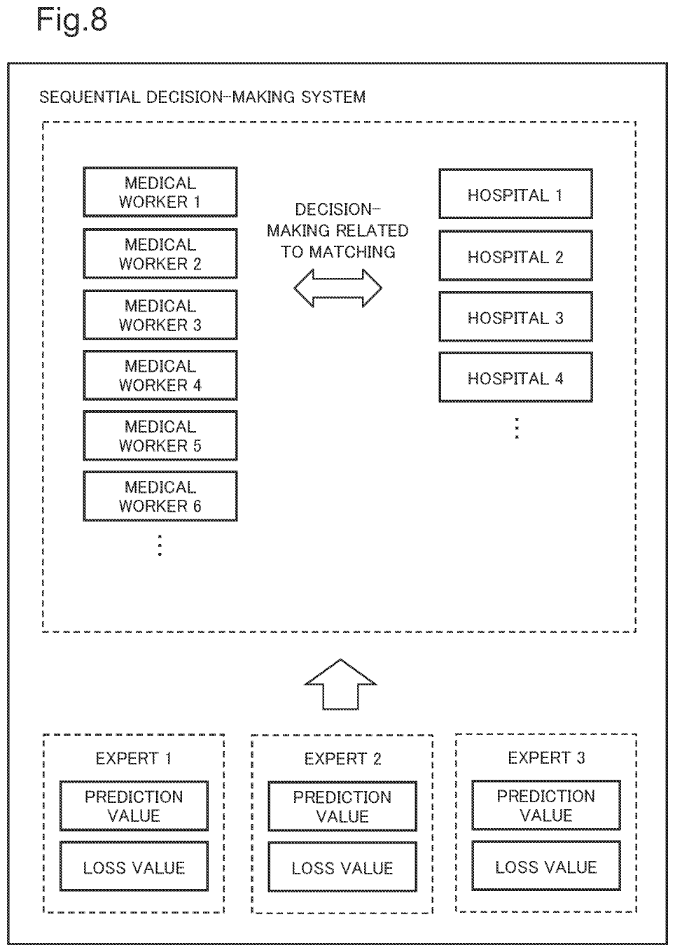

Hereinafter, an application example in which the sequential decision-making system of the present disclosure is applied to medical care and healthcare will be described. FIG. 8 is a diagram schematically illustrating an example of processing performed in the sequential decision-making system.

In the example of the processing performed in the sequential decision-making system illustrated in FIG. 8, the decision-making system 20 performs decision-making related to matching between a plurality of medical workers and a plurality of hospitals, for example. The decision-making system 20 performs the decision-making using the weight for each expert calculated by the optimization system 10. The optimization system 10 acquires a prediction value and a loss value associated with each expert for a plurality of experts at a certain number of times of repetitions (round). The optimization system 10 refers to each of the acquired prediction values and each of the acquired loss values to calculate the weight of the decision-making of each expert. Then, the decision-making system 20 performs the decision-making using the weight of the decision-making of each expert.

When the decision-making result is executed, a loss value corresponding to the next number of times of repetitions is obtained. The optimization system 10 calculates the weight of decision-making by each expert for the next number of times of repetitions based on the loss value obtained by executing the decision-making result and the prediction value corresponding to the loss value.

In the present application example, the input to the expert and the output (prediction value) of each expert are, for example, as follows.

### Example of Input to Expert

Feature quantities of each hospital and each medical worker observed at time t (round t)

Number of visits to each hospital in previous round (round t−1)

### Example of Output of Expert

The assigned hospital for each medical worker at time t (round t).

An example of processing using the sequential decision-making system will be described.

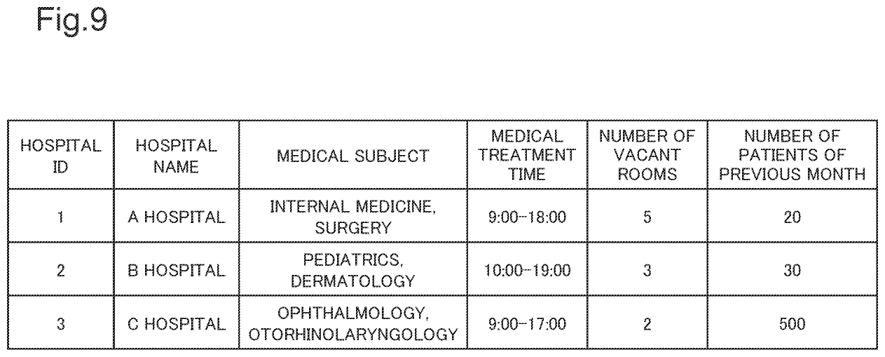

First, an input person in charge in a hospital inputs information (also referred to as hospital data) on a diagnosis status, availability of a hospital room, a medical subject, and a medical treatment time to the decision-making system 20 via a terminal device, for example. Each piece of information input as hospital data is stored, for example, in storage means (not illustrated) of the decision-making system 20. The hospital data is stored for reference by the optimization system 10, for example. FIG. 9 is a diagram illustrating an example of hospital data. In the example of the hospital data of FIG. 9, the hospital data includes, for example, a hospital ID, a hospital name, a medical subject, a medical treatment time, the number of vacant rooms, and the number of patients of the previous month. The hospital ID is an identifier of each hospital. The hospital is a name of a hospital. The medical subject is a name of a subject in which medical care is performed in a hospital. The medical treatment time is a time zone in which medical treatment is performed in a hospital. The number of vacant rooms is the number of hospital rooms that can newly receive patients. The number of patients of the previous month indicates the number of patients who visited last month. The hospital data is not limited to the above.

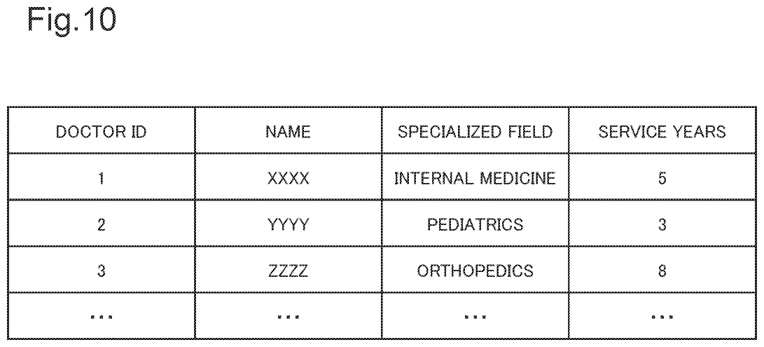

Subsequently, each medical worker inputs his/her data (specialty, service years, desired hospital, or the like) (also referred to as medical worker data) to the decision-making system 20. Each piece of information input as the medical worker data is stored, for example, in storage means (not illustrated) of the decision-making system 20. The medical worker data is stored for reference by the optimization system 10, for example. FIG. 10 is a diagram illustrating an example of the medical worker data. In the example of medical worker data of FIG. 10, the medical worker data includes, for example, a doctor ID, name, specialized field, and service years. The doctor ID is an identifier of each doctor. The name is the name of the doctor. The specialized field is a specialized field of the doctor. The service years are service years of the doctor. The medical worker data is not limited to the above.

Subsequently, the decision-making system 20 refers to the hospital data and the medical worker data, and makes a decision related to matching between the optimal hospital and the medical worker. For example, the decision-making system 20 calculates the prediction value of each of the plurality of experts used for decision-making with reference to hospital data and medical worker data. Then, the decision-making system 20 performs the decision-making related to the optimal matching between the hospital and the medical worker by using the prediction value and the weight of the decision-making of each of the plurality of experts.

The decision-making system 20 presents optimal hospital candidates to the medical worker via a terminal device, for example. The decision-making system 20 presents the optimal candidate for the hospital to the medical worker via a display device (not illustrated) included in the terminal device, for example.

In the decision-making system 20, for example, registration regarding work is performed for each medical worker. In the decision-making system 20, for example, the number of visiting patients in each month (each round) is recorded for each hospital.

The optimization system 10 calculates the weight of the decision-making of each of the plurality of experts based on, for example, a loss value regarding the number of visit patients. Then, the optimization system 10 determines an assignment destination in the next time (next round) based on the calculated weight of decision-making.

Here, a specific example of the loss value is not limited to the present application example, but as an example, a loss value corresponding to a degree of congestion in the hospital can be used.

More specifically, the loss value can be calculated by (actual number of visiting patients in each hospital)−(the number of medical staff assigned to each hospital×the number of patients that can be examined by the medical worker per person).

As described above, as an example, the sequential decision-making system can suitably perform decision-making related to matching between a plurality of medical workers and a plurality of hospitals. The application example of the sequential decision-making system is not limited to the above example. The sequential decision-making system can be applied to various cases related to the decision-making (prediction).

Some or all of the above embodiments may be described as the following supplementary notes, but are not limited to the following.

### [Supplementary Note 1]

An optimization system including:
an acquisition unit that acquires a loss caused as a result of decision-making by a plurality of experts in repetition of decision-making in which the plurality of experts are weighted and combined;
an amplification unit that amplifies each of the plurality of experts into a plurality of experts having different timings for initializing information on weights;
a weight calculation unit that calculates a weight of the decision-making of each of the plurality of experts based on a weight of the decision-making calculated using the loss for each of the experts amplified; and
an output unit that outputs the weight of the decision-making of each of the plurality of experts.

### [Supplementary Note 2]

The optimization system according to Supplementary Note 1, wherein
the amplification unit amplifies each of the plurality of experts into a number of experts obtained by a logarithmic function having the number of times of decision-making as a variable.

### [Supplementary Note 3]

The optimization system according to Supplementary Note 2, wherein
when a base of the logarithmic function is 2, information on the weight is initialized every 2^{s-1} times of decision-making by an s-th expert among the plurality of experts amplified.

### [Supplementary Note 4]

The optimization system according to Supplementary Note 3, wherein
the weight of the s-th expert of each of the plurality of experts among the experts amplified is calculated using the information on the weight in first-previous decision-making in each decision-making performed every 2^{s-1} times in which the information on the weight is initialized.

### [Supplementary Note 5]

The optimization system according to any one of Supplementary Notes 1 to 4, wherein
the amplification unit amplifies each of the plurality of experts so as to include at least one expert whose the information on the weight is not initialized in the entire period of the number of times of the decision-making.

### [Supplementary Note 6]

The optimization system according to Supplementary Note 2, wherein
the amplification unit amplifies each of the plurality of experts into a number of experts obtained by adding a setting value to a number obtained by a logarithmic function having the number of times of decision-making as a variable.

### [Supplementary Note 7]

The optimization system according to any one of Supplementary Notes 1 to 4, further including a storage unit that stores the information on the weight of each of the experts amplified in a storage device,
in which the weight calculation unit stores the amplified information on the weight for each expert in the storage unit, and reads the information on the weight one time before from the storage unit at a timing when the information on the weight is not initialized.

### [Supplementary Note 8]

An optimization method including:
acquiring a loss caused as a result of decision-making by a plurality of experts in repetition of decision-making in which the plurality of experts are weighted and combined;
amplifying each of the plurality of experts into a plurality of experts having different timings of initializing information on weights;
calculating a weight of the decision-making of each of the plurality of experts based on a weight of decision-making calculated using the loss for each of the experts amplified; and
outputting the weight of the decision-making of each of the plurality of experts.

### [Supplementary Note 9]

The optimization method according to Supplementary Note 8, wherein
each of the plurality of experts is amplified into a number of experts obtained by a logarithmic function having the number of times of decision-making as a variable.

### [Supplementary Note 10]

The optimization method according to Supplementary Note 9, wherein
when a base of the logarithmic function is 2, information on the weight is initialized every 2^{s-1} times of decision-making by an s-th expert among the plurality of experts amplified.

### [Supplementary Note 11]

The optimization method according to Supplementary Note 10, wherein
the weight of the s-th expert of each of the plurality of experts among the experts amplified is calculated using the information on the weight in first-previous decision-making in each decision-making performed every 2^{s-1} times in which the information on the weight is initialized.

### [Supplementary Note 12]

The optimization method according to any one of Supplementary Notes 8 to 11, wherein
each of the plurality of experts is amplified so as to include at least one expert whose the information on the weight is not initialized in the entire period of the number of times of the decision-making.

### [Supplementary Note 13]

The optimization method according to Supplementary Note 9, wherein
each of the plurality of experts is amplified into a number of experts obtained by adding a setting value to a number obtained by a logarithmic function having the number of times of decision-making as a variable.

### [Supplementary Note 14]

The optimization method according to any one of Supplementary Notes 8 to 11, further including:
storing the information on the weight of each of the experts amplified in a storage device, wherein
in which the amplified information on the weight for each expert is stored in the storage unit, and the information on the weight one time before from the storage unit is read at a timing when the information on the weight is not initialized.

### [Supplementary Note 15]

A non-transitory recording medium recording an optimization program that causes a computer to execute:
acquiring a loss caused as a result of decision-making by a plurality of experts in repetition of decision-making in which the plurality of experts are weighted and combined;
amplifying each of the plurality of experts into a plurality of experts having different timings of initializing information on weights;
calculating a weight of the decision-making of each of the plurality of experts based on a weight of decision-making calculated using the loss for each of the experts amplified; and
outputting the weight of the decision-making of each of the plurality of experts.

### [Supplementary Note 16]

The non-transitory recording medium recording the optimization program according to Supplementary Note 15,
the optimization program further causes the computer to execute: amplifying each of the plurality of experts into a number of experts obtained by a logarithmic function having the number of times of decision-making as a variable.

### [Supplementary Note 17]

The non-transitory recording medium recording the optimization program according to Supplementary Note 16, wherein
when a base of the logarithmic function is 2, information on the weight is initialized every 2^{s-1} times of decision-making by an s-th expert among the plurality of experts amplified.

### [Supplementary Note 18]

The non-transitory recording medium recording the optimization program according to Supplementary Note 17, wherein
the weight of the s-th expert of each of the plurality of experts among the experts amplified is calculated using the information on the weight in first-previous decision-making in each decision-making performed every 2^{s-1} times in which the information on the weight is initialized.

### [Supplementary Note 19]

The non-transitory recording medium recording the optimization program according to any one of Supplementary Notes 15 to 18, wherein
the optimization program further causes the computer to execute: amplifying each of the plurality of experts so as to include at least one expert whose the information on the weight is not initialized in the entire period of the number of times of the decision-making.

### [Supplementary Note 20]

The non-transitory recording medium recording the optimization program according to Supplementary Note 16, wherein
the optimization program further causes the computer to execute: amplifying each of the plurality of experts into a number of experts obtained by adding a setting value to a number obtained by a logarithmic function having the number of times of decision-making as a variable.

### [Supplementary Note 21]

The non-transitory recording medium recording the optimization program according to Supplementary Note 16, wherein
the optimization program further causes the computer to execute:
storing information on the weight of each of the experts amplified in a storage device; and
storing the amplified information on the weight for each expert in the storage unit, and reading the information on the weight one time before from the storage unit at a timing when the information on the weight is not initialized.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. An optimization system comprising:
at least one memory storing instructions; and
at least one processor configured to access the at least one memory and execute the instructions to:
acquire a loss caused as a result of decision-making by a plurality of experts in repetition of decision-making in which the plurality of experts are weighted and combined;
amplify each of the plurality of experts into a plurality of experts having different timings for initializing information on weights;
calculate a weight of the decision-making of each of the plurality of experts based on a weight of the decision-making calculated using the loss for each of the experts amplified; and
output the weight of the decision-making of each of the plurality of experts.

2. The optimization system according to claim 1, wherein
the at least one processor is further configured to execute the instructions to:
amplify each of the plurality of experts into a number of experts obtained by a logarithmic function having the number of times of decision-making as a variable.

3. The optimization system according to claim 2, wherein when a base of the logarithmic function is 2, information on the weight is initialized every 2^{s-1} times of decision-making by an s-th expert among the plurality of experts amplified.

4. The optimization system according to claim 3, wherein the weight of the s-th expert of each of the plurality of experts among the experts amplified is calculated using the information on the weight in first-previous decision-making in each decision-making performed every 2^{s-1} times in which the information on the weight is initialized.

5. The optimization system according to claim 1, wherein
the at least one processor is further configured to execute the instructions to:
amplify each of the plurality of experts so as to include at least one expert whose the information on the weight is not initialized in the entire period of the number of times of the decision-making.

6. The optimization system according to claim 2, wherein
the at least one processor is further configured to execute the instructions to:
amplify each of the plurality of experts into a number of experts obtained by adding a setting value to a number obtained by a logarithmic function having the number of times of decision-making as a variable.

7. The optimization system according to claim 1, wherein
the at least one processor is further configured to execute the instructions to:
store the amplified information on the weight for each expert in a storage; and read the information on the weight one time before from the storage at a timing when the information on the weight is not initialized.

8. An optimization method comprising:
acquiring a loss caused as a result of decision-making by a plurality of experts in repetition of decision-making in which the plurality of experts are weighted and combined;
amplifying each of the plurality of experts into a plurality of experts having different timings of initializing information on weights;
calculating a weight of the decision-making of each of the plurality of experts based on a weight of decision-making calculated using the loss for each of the experts amplified; and
outputting the weight of the decision-making of each of the plurality of experts.

9. The optimization method according to claim 8, wherein
each of the plurality of experts is amplified into a number of experts obtained by a logarithmic function having the number of times of decision-making as a variable.

10. The optimization method according to claim 9, wherein
when a base of the logarithmic function is 2, information on the weight is initialized every 2^{s-1} times of decision-making by an s-th expert among the plurality of experts amplified.

11. The optimization method according to claim 10, wherein
the weight of the s-th expert of each of the plurality of experts among the experts amplified is calculated using the information on the weight in first-previous decision-making in each decision-making performed every 2^{s-1} times in which the information on the weight is initialized.

12. The optimization method according to 8, wherein
each of the plurality of experts is amplified so as to include at least one expert whose the information on the weight is not initialized in the entire period of the number of times of the decision-making.

13. The optimization method according to claim 9, wherein
each of the plurality of experts is amplified into a number of experts obtained by adding a setting value to a number obtained by a logarithmic function having the number of times of decision-making as a variable.

14. The optimization method according to claim 8, further including:
storing the information on the weight of each of the experts amplified in a storage device, wherein
the amplified information on the weight for each expert is stored in the storage unit, and the information on the weight one time before from the storage unit is read at a timing when the information on the weight is not initialized.

15. A non-transitory recording medium recording an optimization program that causes a computer to execute:
acquiring a loss caused as a result of decision-making by a plurality of experts in repetition of decision-making in which the plurality of experts are weighted and combined;
amplifying each of the plurality of experts into a plurality of experts having different timings of initializing information on weights;
calculating a weight of the decision-making of each of the plurality of experts based on a weight of decision-making calculated using the loss for each of the experts amplified; and
outputting the weight of the decision-making of each of the plurality of experts.

16. The non-transitory recording medium recording the optimization program according to claim 15, wherein
the optimization program further causes the computer to execute: amplifying each of the plurality of experts into a number of experts obtained by a logarithmic function having the number of times of decision-making as a variable.

17. The non-transitory recording medium recording the optimization program according to claim 16, wherein
when a base of the logarithmic function is 2, information on the weight is initialized every 2^{s-1} times of decision-making by an s-th expert among the plurality of experts amplified.

18. The non-transitory recording medium recording the optimization program according to claim 17, wherein
the weight of the s-th expert of each of the plurality of experts among the experts amplified is calculated using the information on the weight in first-previous decision-making in each decision-making performed every 2^{s-1} times in which the information on the weight is initialized.

19. The non-transitory recording medium recording the optimization program according to claim 15, wherein
the optimization program further causes the computer to execute: amplifying each of the plurality of experts so as to include at least one expert whose the information on the weight is not initialized in the entire period of the number of times of the decision-making.

20. The non-transitory recording medium recording the optimization program according to claim 16, wherein
the optimization program further causes the computer to execute: amplifying each of the plurality of experts into a number of experts obtained by adding a setting value to a number obtained by a logarithmic function having the number of times of decision-making as a variable.
